(19) United States
(12) Patent Application Publication
(10) Pub. No.: US 2007/0109477 A1
(43) Pub. Date: May 17, 2007

(54) Vertical alignment mode liquid crystal display

(75) Inventors: Kyung Jun Lee, Seoul (KR); Do Hyeon Baek, Seoul (KR)

Correspondence Address: SEYFARTH SHAW LLP, 131 S. DEARBORN ST., SUITE2400, CHICAGO, IL, 60603-5803, US

(73) Assignee: Boe Hydis Technology Co., Ltd.

(21) Appl. No.: 11/595,454

(22) Filed: Nov. 9, 2006

(30) Foreign Application Priority Data
Nov. 11, 2005 (KR) 10-2005-0108015

(51) Int. Cl. G02F 1/1337

(52) U.S. Cl. 349/129

(57) ABSTRACT

Disclosed is a vertical alignment mode liquid crystal display. The liquid crystal display includes an array substrate which includes a pixel electrode having a plurality of first patterns which regularly repeat, a color filter substrate which includes a color resin layer having a plurality of second patterns which regularly repeat, and a common electrode formed on the color resin layer, and which is disposed so as to face the array substrate such that the first patterns intersect with the second patterns, and a liquid crystal layer interposed between the array substrate and the color filter substrate. The pixel electrode has connection portions and slits between the first patterns, and the color resin layer has connection portions, protrusions, or grooves between the second patterns. The first and second patterns have an identical shape, or are of different sizes. The first and second patterns rotate to a certain angle.

### BACKGROUND OF THE INVENTION

1. Field of the invention

The present invention relates to a liquid crystal display, and more particularly to a vertical alignment mode liquid crystal display, which has a high response rate.

2. Description of the Prior Art

Liquid crystal displays have been developed as replacement of cathode-ray tubes. Especially, as a thin film transistor liquid crystal display has realized a screen which has high quality and large scale and is colorized enough to match the screen by the cathode-ray tube, the thin film transistor liquid crystal display has come into the significant spotlight in the market for lap-top computers and monitors. Furthermore, the liquid crystal display is expected to make inroads into television receiver markets.

On the other hand, the thin film transistor liquid crystal display has usually used a twist nematic mode as its driving mode. The twist nematic mode maintains stable processes and yield, but has much narrow visual field angle and a low response rate. In order to settle such problems, vertical alignment mode and in-plane switching mode liquid crystal displays have been proposed.

Especially, the vertical alignment mode liquid crystal display is currently expected to be a leading display to enter into the television receiver market. Thus, technologies relating to the vertical alignment mode liquid crystal display have been developed.

The vertical alignment mode liquid crystal display includes a liquid crystal layer interposed between upper and lower glass substrates having driving electrodes for driving liquid crystal. The liquid crystal layer is formed with liquid crystal having a negative dielectric anisotropy. Further, the liquid crystal display has vertical alignment layers formed on opposed surfaces of the upper and lower glass substrates thereof. Furthermore, polarizing plates are attached to the backsides of the opposed surfaces of the upper and lower glass substrates in such a manner that their polarizing axes intersect with each other.

In the vertical alignment mode liquid crystal display, before an electric field is formed, liquid crystals are vertically aligned on the substrate by the influence of the vertical alignment layers, so that a dark screen is displayed due to the polarizing axes of the upper and lower polarizing plates, which vertically intersect with each other. On the other hand, when the electric field is formed between the driving electrodes for driving the liquid crystal, the liquid crystals are twisted such that its longer axis makes a right angle with respect to the direction of the electric field. Thus, light leaks through the twisted liquid crystals and thereby produces a white screen.

In the vertical alignment mode liquid crystal display, however, the liquid crystals have its refractive-index anisotropy so as to cause the liquid crystal display to display different colors, based on the angle of the sight. For example, before the electric field is created, since all the liquid crystal molecules are vertically aligned on the substrate, the liquid crystal display shows a complete dark screen in a view from a front of the screen, but allows light to leak through lateral sides of the screen, thereby degrading image quality of the screen.

Therefore, vertical alignment mode liquid crystal displays having various structures have been developed in order to compensate for the degradation of image quality due to the refractive-index anisotropy of the liquid crystals.

Korean laid-open Patent Publication No. 2005-0020945 discloses a vertical alignment mode liquid crystal display, in which pixel patterns having hexagonal or circular shape are formed on either an array substrate or a color filter substrate, and small protrusion patterns are formed on the remaining substrate, in order to control the driving of liquid crystal. Furthermore, the liquid crystal display has sub-pixels, each of which has circular or hexagonal shape.

However, the vertical alignment mode liquid crystal display according to the above Korean Patent Application requires an additional process for forming the small protrusion patterns acting as driving axes of the liquid crystals. Especially, if the sub-pixel has a size greater than a certain size, it is difficult to obtain stable driving characteristics for the liquid crystals only by the disclosed structure.

### SUMMARY OF THE INVENTION

Accordingly, the present invention has been developed in order to solve the above-mentioned problems occurring in the prior art, and an object of the present invention is to provide a vertical alignment mode liquid crystal display, which can achieve stable operation characteristics of liquid crystals without an additional process.

In order to accomplish these objects of the present invention, there is provided a vertical alignment mode liquid crystal display, which comprises: an array substrate which includes a pixel electrode having a plurality of first patterns which regularly repeat; a color filter substrate which includes a color resin layer having a plurality of second patterns which regularly repeat, and a common electrode formed on the color resin layer, the color filter substrate being disposed to face the array substrate such that the first patterns intersect with the second patterns; and a liquid crystal layer interposed between the array substrate and the color filter substrate.

The pixel electrode has connection portions and slits between the first patterns which regularly repeat, and the color resin layer has connection portions, protrusions, or grooves between the second patterns which regularly repeat.

The first and second patterns may have an identical shape, or be of different shapes. In the case where the first and second patterns have an identical shape, the first and second patterns may have an identical size, or be of different sizes. In addition, the first and second patterns may rotate to a certain angle.

### BRIEF DESCRIPTION OF THE DRAWINGS

The above and other objects, features, and advantages of the present invention will be more apparent from the following detailed description taken in conjunction with the accompanying drawings, in which:

FIG. 1 is a schematic sectional view showing a vertical alignment mode liquid crystal display according to the first embodiment of the present invention;

FIG. 2 is a plan view illustrating patterns of a pixel electrode which can be applied to the vertical alignment mode liquid crystal display shown in FIG. 1;

FIG. 3 is a plan view illustrating patterns of the other pixel electrode which can be applied to the vertical alignment mode liquid crystal display shown in FIG. 1;

FIG. 4 is a plan view illustrating patterns of a color resin layer which can be applied to the vertical alignment mode liquid crystal display shown in FIG. 1;

FIG. 5 is a plan view illustrating the patterns of the other color resin layer which can be applied to the vertical alignment mode liquid crystal display shown in FIG. 1;

FIG. 6 is a plan view showing patterns of a pixel electrode and a color resin layer which overlap, according to the first embodiment of the present invention;

FIG. 7 is a plan view showing patterns of a pixel electrode and a color resin layer which overlap, according to the second embodiment of the present invention;

FIG. 8 is a plan view showing patterns of a pixel electrode and a color resin layer which overlap, according to the third embodiment of the present invention;

FIG. 9 is a plan view showing patterns of a pixel electrode and a color resin layer which overlap, according to the fourth embodiment of the present invention;

FIG. 10 is a plan view showing patterns of a pixel electrode and a color resin layer which overlap, according to the fifth embodiment of the present invention;

FIG. 11 is a plan view showing patterns of a pixel electrode and a color resin layer which overlap, according to the sixth embodiment of the present invention; and

FIG. 12 is a plan view showing patterns of a pixel electrode and a color resin layer according to the seventh embodiment of the present invention.

### DETAILED DESCRIPTION OF THE PREFERRED EMBODIMENTS

Hereinafter, a preferred embodiment of the present invention will be described with reference to the accompanying drawings.

### Embodiment 1

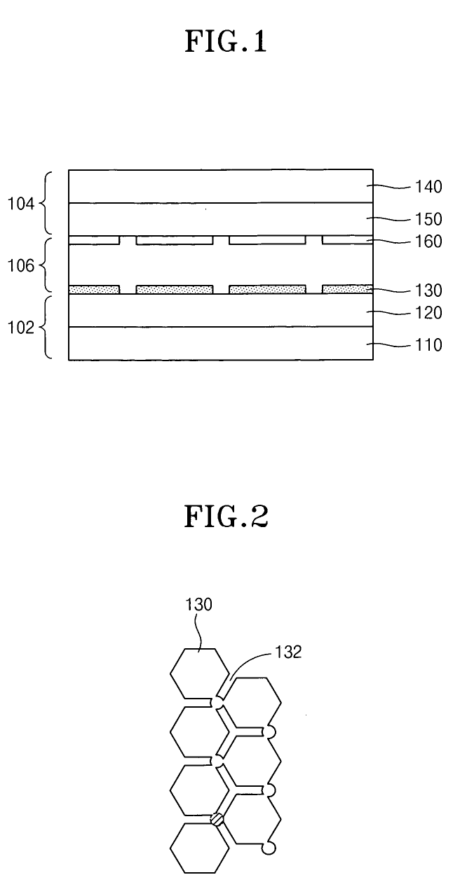

FIG. 1 is a schematic sectional view showing a vertical alignment mode liquid crystal display according to the first embodiment of the present invention. As shown in FIG. 1, the vertical alignment mode liquid crystal display 100 according to the present invention includes an array substrate 102, a color filter substrate 104, and a liquid crystal layer 106 interposed between the array substrate 102 and the color filter substrate 104. The array substrate 102 has a lower glass substrate 110, an insulation layer 120, and a pixel electrode 130. The pixel electrode 130 has a plurality of first patterns which regularly repeat, and connection portions and slits formed between the first patterns, as described below.

The color filter substrate 104 includes an upper glass substrate 140, a color resin layer 150 having red, blue, and green colors, and a common electrode 160. The color resin layer 150 has a plurality of second patterns which regularly repeat, and connection portions and protrusions formed between the second patterns. The common electrode 160 is formed on the color resin layer 150 having the second patterns. Therefore, the common electrode 160 also has the same patterns as the second patterns of the color resin layer 150.

Especially, the array substrate 102 and the color filter substrate 104 are disposed to face each other such that the first patterns of the pixel electrode 130 intersect with the second patterns of the color resin layer 150.

On the other hand, a plurality of gate and data lines are arranged with an insulation layer 120 every between them, while thin film transistors are formed at points that the gate lines and the data lines intersect with each other, as not shown. Further, black matrices are formed on the upper glass substrate 140. Vertical alignment layers are respectively formed at an uppermost portion of opposed surfaces of the array substrate 102 and the color filter substrate 104. In addition, polarizing plates are respectively attached to a rear surface of the lower glass substrate 110 and the upper glass substrate 140 so that the polarizing axes of the polarizing plates intersect with each other.

FIG. 2 is a plan view illustrating patterns of a pixel electrode which can be applied to the vertical alignment mode liquid crystal display shown in FIG. 1. As shown in FIG. 2, the pixel electrode 130 contains the first patterns which regularly repeat. The first patterns have slits 132 formed between the first patterns 130 and are connected to one another by the connection portions. For example, the first patterns may have circular, polygonal, diamond, or any certain shape. Here, the first patterns are shown, which have hexagonal shapes. The hexagonal-shaped patterns are connected to one another at each corner thereof.

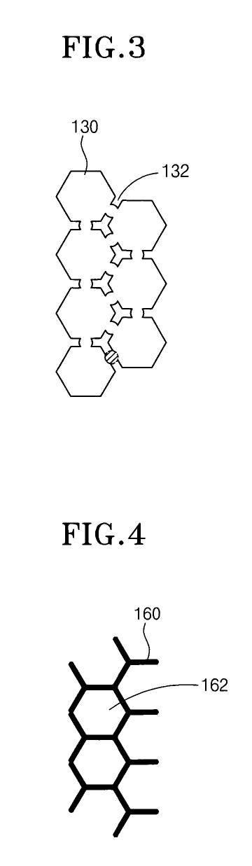

FIG. 3 is a plan view illustrating the other patterns of the pixel electrode which can be applied to the vertical alignment mode liquid crystal display shown in FIG. 1. As shown in FIG. 3, the pixel electrode 130 is identical with that of FIG. 2, except that sides of the hexagonal-shaped patterns are connected to one another. If a mask which has hexagonal patterns formed therein is used for forming such a pixel electrode 130, it is possible to obtain the pixel electrode 130 having the hexagonal-shaped patterns using an existing process.

FIG. 4 is a plan view illustrating patterns of a color resin layer which can be applied to the vertical alignment mode liquid crystal display shown in FIG. 1. As shown in FIG. 4, the color resin layer 150 contains the second patterns which regularly repeat. The second patterns have protrusions which are formed on a surface of the color resin layer 150 contacting with the common electrode. Further, the patterns are connected to one another by the connection portions. Specially, the second patterns have the same shape and size as the first patterns of the pixel electrode 130. For example, the first patterns may have circular, polygonal, diamond, or any given shape. Here, the second patterns are shown which have hexagonal shapes and the same size as that of the first patterns.

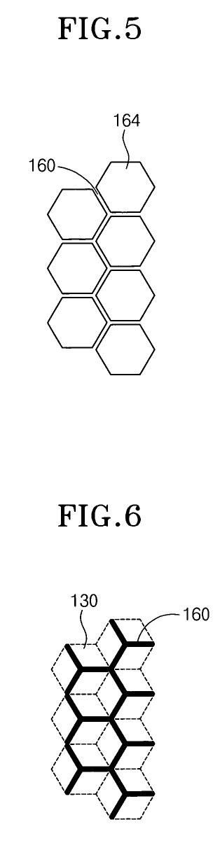

FIG. 5 is a plan view illustrating the other patterns of the color resin layer which can be applied to the vertical alignment mode liquid crystal display shown in FIG. 1. As shown in FIG. 5, the color resin layer 150 is identical with that of FIG. 4, except that the second patterns is formed in such a manner that grooves 154 are formed in the color resin layer 150. Here, in order to form the second patterns in the color resin layer 150 by using the grooves 154, a mask capable of forming hexagonal shapes is used in forming the color resin layer 150. Thus, the color resin layer 150 having the second patterns can be formed without an additional process.

FIG. 6 is a plan view showing patterns of a pixel electrode and a color resin layer which overlap, according to the first embodiment of the present invention. As shown in FIG. 6, the pixel electrode 130 and the color resin layer 150 are positioned such that the first patterns intersect with the second patterns. That is, corners of one hexagonal pattern of the first patterns are alternately placed at a center portion of one hexagonal pattern of the second patterns. Similarly, corners of one hexagonal pattern of the second patterns are alternately placed at a center portion of one hexagonal pattern of the first patterns.

Accordingly, since the array substrate 102 and the color filter substrate 104 are arranged and aligned so that the first patterns of the array substrate 102 intersect with the second patterns of the color filter substrate 104, a distortion of the electric field is caused by the slits 132 and the protrusions 152 in the vertical alignment mode liquid crystal display according to the present invention, so that multiple domains are easily formed to secure a broad visual field angle.

Further, since the grooves are formed in the color resin layer 150 during the patterning of the color resin layer 150 in the case where the second patterns of the color filter substrate 104 are formed in the formation of the groove, the vertical alignment liquid crystal display according to the present invention does not require additional processes in order to form the multiple domains.

### Embodiment 2

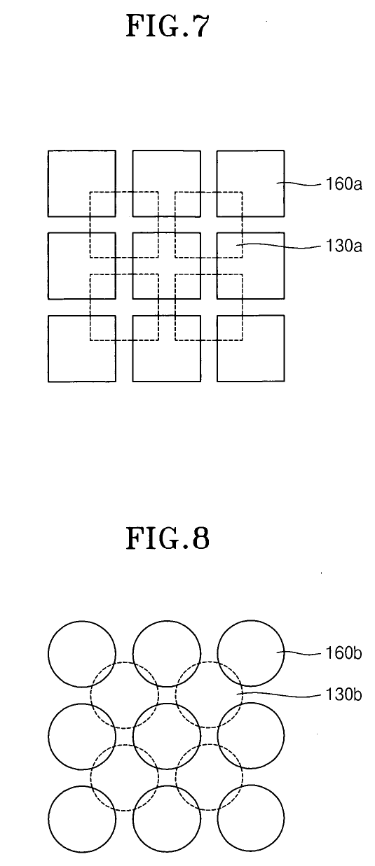

FIG. 7 is a plan view showing patterns of a pixel electrode and a color resin layer which overlap, according to the second embodiment of the present invention.

As shown in FIG. 7, the second embodiment has the identical structure with that of the first embodiment, except that the first patterns of a pixel electrode 130a and the second patterns of a color resin layer 150a are square-shaped patterns. That is, the first patterns of the pixel electrode 130a and the second patterns of the color resin layer 150a are achieved by the square patterns having the identical size.

### Embodiment 3

FIG. 8 is a plan view showing patterns of a pixel electrode and a color resin layer which overlap, according to the third embodiment of the present invention.

As shown in FIG. 8, the third embodiment has an identical structure to that of the first embodiment, except that the first patterns of a pixel electrode 130b and the second patterns of a color resin layer 150b are circle-shaped patterns. That is, the first patterns of the pixel electrode 130b and the second patterns of the color resin layer 150b are achieved by the circular patterns having the identical size.

### Embodiment 4

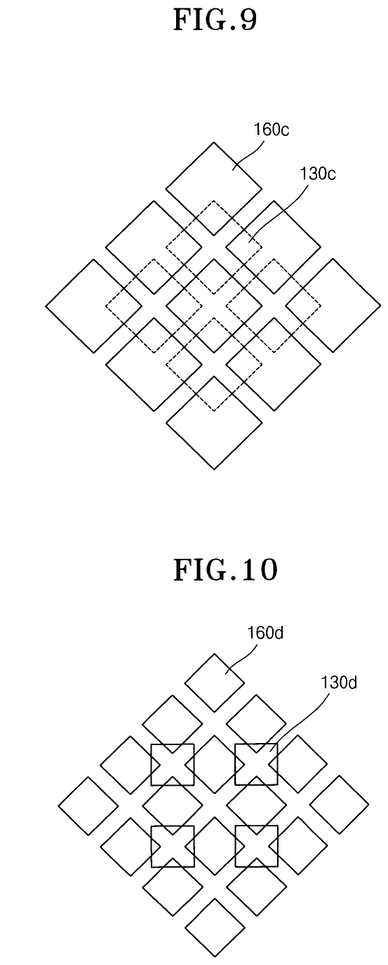

FIG. 9 is a plan view showing patterns of a pixel electrode and a color resin layer which overlap, according to the fourth embodiment of the present invention.

As shown in FIG. 9, the fourth embodiment has an identical structure to that of the first embodiment, except that the first patterns of a pixel electrode 130c and the second patterns of a color resin layer 150c are diamond-shaped patterns. That is, the first patterns of the pixel electrode 130c and the second patterns of the color resin layer 150c are achieved by the diamond patterns having an identical size.

### Embodiment 5

FIG. 10 is a plan view showing patterns of a pixel electrode and a color resin layer which overlap, according to the fifth embodiment of the present invention.

As shown in FIG. 10, first patterns of a pixel electrode 130d and second patterns of a color resin layer 150d have an identical shape, but the first patterns are rotated to a certain angle relating to the second patterns. Specifically, the first patterns of the pixel electrode 130d are identical with the second patterns of the color resin layer 150d which are rotated to an angle of 45 degrees. Especially, the patterns of the pixel electrode 130d and the color resin layer 150d have polygon, diamond, or any given shapes, except for a circular shape of which phase is not changed by rotation of the patterns.

### Embodiment 6

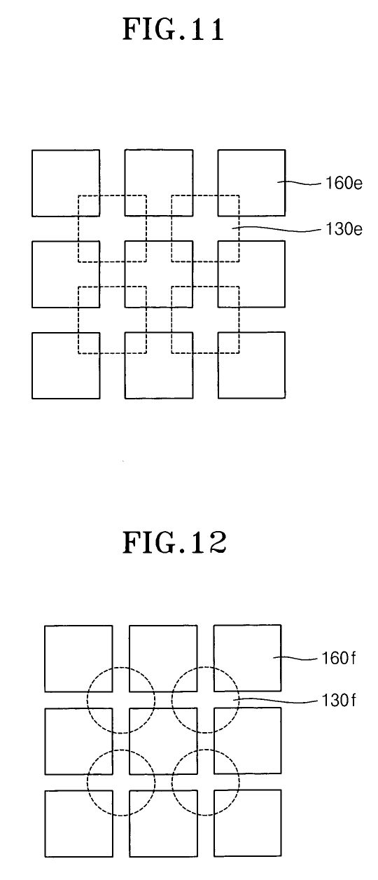

FIG. 11 is a plan view showing patterns of a pixel electrode and a color resin layer which overlap, according to the sixth embodiment of the present invention.

As shown in FIG. 11, first patterns of a pixel electrode 130e and second patterns of a color resin layer 150e are identical in shape and size. Meanwhile, the first patterns of the pixel electrode 130e overlap with the second patterns of the color resin layer 150e such that one of the first patterns involves a corner of each of four patterns of the second patterns.

### Embodiment 7

FIG. 12 is a plan view showing patterns of a pixel electrode and a color resin layer according to the seventh embodiment of the present invention.

As shown in FIG. 12, first patterns of a pixel electrode 130f and second patterns of a color resin layer 150f have different shapes. That is, the second patterns of the color resin layer 150f have square shape, while the first patterns of the pixel electrode 130f. Meanwhile, the first patterns of the pixel electrode 130f overlap with the second patterns of the color resin layer 150f such that one of the first patterns includes a corner of each of four patterns of the second patterns.

As described above, according to the present invention, since the patterns of the array substrate and the color filter substrate are arranged on the array substrate and the color filter substrate so as to intersect with one another, it is possible to efficiently control an operation of liquid crystal in whole region of the liquid crystal display. In addition, the patterns are formed in the formation of grooves within the color filter substrate during patterning of the color resin layer. Thus, additional processes are not required for forming the multiple domains.

Further, since the patterns are arranged to intersect with one another so that multiple domains are formed, it is possible to secure a broad visual field angle and to simplify process for forming multiple domains, thereby reducing processing time.

While a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A vertical alignment mode liquid crystal display, comprising:
an array substrate which includes a pixel electrode having a plurality of first patterns which regularly repeat;
a color filter substrate which includes a color resin layer having a plurality of second patterns which regularly repeat, and a common electrode formed on the color resin layer, the color filter substrate being disposed so as to face the array substrate such that the first patterns intersect with the second patterns; and
a liquid crystal layer interposed between the array substrate and the color filter substrate.

2. The vertical alignment mode liquid crystal display as claimed in claim 1, wherein the pixel electrode has connection portions and slits between the first patterns which regularly repeat, and the color resin layer has connection portions, protrusions, or grooves between the second patterns which regularly repeat.

3. The vertical alignment mode liquid crystal display as claimed in claim 1, wherein the first and second patterns have an identical shape.

4. The vertical alignment mode liquid crystal display as claimed in claim 3, wherein the first and second patterns have an identical size.

5. The vertical alignment mode liquid crystal display as claimed in claim 3, wherein the first and second patterns are different sizes.

6. The vertical alignment mode liquid crystal display as claimed in claim 3, wherein the first and second patterns rotate to a certain angle.

7. The vertical alignment mode liquid crystal display as claimed in claim 1, wherein the first and second patterns are different shapes.
